(19) United States
(12) Patent Application Publication
(10) Pub. No.: US 2005/0210329 A1
(43) Pub. Date: Sep. 22, 2005

(54) Facilitating system diagnostic functionality through selective quiescing of system component sensor devices

(75) Inventors: Kenneth S. Goss, Austin, TX (US); Navin D. Boppuri, Austin, TX (US)

Correspondence Address: Raymond M. Galasso;Simon, Galasso & Frantz PLC, P.O. Box 26503, Austin, TX, 78755-0503, US

(73) Assignee: NEWISYS, INC.

(21) Appl. No.: 10/803,869

(22) Filed: Mar. 18, 2004

(51) Int. Cl. G06F 11/00

(52) U.S. Cl. 714/25

(57) ABSTRACT

A driver for a system component sensor device in a computer system comprises a diagnostic mode of operation configured for enabling selective execution of diagnostic functionality on a corresponding system component sensor device while concurrently permitting execution of system management to be performed via system component sensors in a system management mode of operation. The diagnostic mode of operation includes disabling the corresponding system component device with respect to system management functionality and access by non-diagnostic users. The driver further comprises at least one of a parent driver device interface configured for controlling modes of operation of a group of child sensor devices and a plurality of child device driver interfaces each configured for controlling modes of operation of a respective one of the child sensor devices. The corresponding system component sensor device is one of the sensor devices and sets the diagnostic mode of operation using one of the device driver interfaces.

### FIELD OF THE DISCLOSURE

The disclosures made herein relate generally to computer systems and, more particularly, to facilitating system diagnostic functionality through selective quiescing of system component sensor devices.

### BACKGROUND

Information and the means to exchange information via computing technology have grown to be sophisticated and complex compared to the state of the art a mere 15 years ago. Today, computers have become critical to the efficient function and conduct of business in numerous sectors worldwide, ranging from governments to corporations and small businesses. The increasingly critical role of computing assets has, in turn, been the basis for concern from various sectors as to the reliability and manageability of computing assets. System downtime events resulting from hardware problems result in considerable expense to businesses in the retail and securities industries, among others. Moreover, with networked applications taking on more essential business roles daily, the cost of system downtime will continue to grow.

Diagnosing and repairing a hardware-related problem are aspects of system downtime that have significant costs associated therewith. Many computer systems provide only minimal diagnostic functions, and these generally only to the level of whether or not the system is running. Embedded diagnostic codes such as power-on self-test (POST) exist within a computer system and can perform limited diagnostic tests automatically when a computer is powered up. The POST series of diagnostic tests performed varies, depending on the BIOS configuration, but typically POST tests the RAM (random access memory), keyboard, and access to every disk drive. If these tests are successful, POST initiates loading of the operating system and the computer boots. Otherwise, the fault area is reported/isolated for analysis. However, POST executes its diagnostic functions only upon power-up. POST is not capable of diagnostic monitoring during normal system operations.

To aid in reducing system downtime, computer systems are known to include or enable system management functionality for designated system components (e.g., monitoring operating conditions of such system components, assessing functional condition, etc). Conventional approaches for providing diagnostic functionality for such designated system components generally require that nearly all, if not all, system management functionality for every designated system component be disabled (e.g., suspended) in order to execute diagnostics on various system component sensing devices. Accordingly, even if diagnostic service is desired on only a single one of the system components of the computer system (e.g., server), at least a significant portion of system management functionality is disabled for every system component in the computer system.

PCI Hot-Plug is a known mechanism that allows a system component to be individually subjected to diagnostics, without adversely affecting system management and/or operation of other system components. Specifically, PCI Hot Plug permits system components to be physically removed and re-installed in a computer system without having to power down and re-boot the computer system. However, while a system component is removed from the computer system, such system component is inherently no longer accessible by an operating system of the computer system and system functionality enabled by such system component is at least partially disabled.

Therefore, facilitating system diagnostic functionality in a manner that overcomes limitations associated with conventional approaches facilitating system diagnostic functionality would be useful and novel.

### SUMMARY OF THE DISCLOSURE

Embodiments of the inventive disclosures made herein are comprised by methods and/or equipment configured for facilitating system diagnostic functionality through selective quiescing of one or more system component sensor devices. Quiescing is defined herein to include temporarily disabling a designated system component sensor device with respect to non-diagnostic functionality (e.g., system management functionality) and enabling any necessary diagnostic action to be performed in support of diagnostic functionality. Such embodiments of the inventive disclosures enable diagnostic functionality to be carried out on one or more quiesced system component sensor devices, while concurrently permitting system management functionality to continue via non-quiesced system management sensor devices.

In one embodiment, a driver for a system component sensor device in a computer system comprises a diagnostic mode of operation configured for enabling selective execution of diagnostic functionality on a corresponding system component sensor device (i.e., the quiesced system component) while concurrently permitting execution of system management to be performed via system component sensors in a system management mode of operation (i.e., non-quiesced system components). The diagnostic mode of operation includes disabling the corresponding system component device with respect to system management functionality and access by non-diagnostic users and notifying non-diagnostic users of the present state of the quiesced system component. The driver further comprises a parent driver device interface configured for controlling modes of operation of a group of child sensor devices and includes a plurality of child device driver interfaces each configured for controlling modes of operation of a respective one of the child sensor devices. The corresponding system component sensor device is one of the child sensor devices and is set to the diagnostic mode of operation using one of the device driver interfaces.

In another embodiment, a method for facilitating diagnostic functionality in a computer system comprises setting a designated sensor device of a system component to a diagnostic mode of operation, executing system management functionality on system components served by non-designated sensor devices while the designated sensor device is in the diagnostic mode of operation, and executing diagnostic functionality on the designated sensor device while executing the system management functionality and while the designated sensor device is in the diagnostic mode of operation. The operation of setting to the diagnostic mode of operation includes simultaneously setting a plurality of sensor devices to the diagnostic mode of operation, wherein the designated sensor device is one of the sensor devices. The operation of setting to the diagnostic mode of operation further includes disabling the designated sensor device from at least one of providing system management functionality and being accessed by non-diagnostic users. Setting the diagnostic mode of operation includes setting a device driver of the designated sensor device to the diagnostic mode of operation (i.e., quiescing the device driver).

Accordingly, it is a principal object of the inventive disclosures made herein to provide methods and equipment that enable system diagnostic functionality to be performed on a system component sensor device of a computer system in a manner that does not require all system management functionality to be disabled while performing such system diagnostics.

It is another object of the inventive disclosures made herein to allow system diagnostic functionality to be facilitated on a single system component sensor device while system management functionality is facilitated via all other system component sensor devices.

It is a further object of the inventive disclosures made herein to allow a diagnostics user to selectively quiesce individual child devices and/or selectively quiesce a group of child devices in a simultaneous manner.

Still another object of the inventive disclosures made herein is to facilitate diagnostic functionality with minimal adverse impact on system down-time.

Still another object of the inventive disclosures made herein is to allow a quiesced system component sensor device to remain accessible, thus allowing diagnostic procedures to be implemented without disconnecting physical hardware.

Yet another object of the inventive disclosures made herein is to allow selective quiescing of system component sensor devices without requiring modification of systems management software.

These and other objects of the inventive disclosures made herein will become readily apparent upon further review of the following specification and associated drawings.

### BRIEF DESCRIPTION OF THE DRAWINGS

FIG. 1 depicts a method configured for carrying out system management and diagnostic functionality in accordance with an embodiment of the inventive disclosures made herein.

FIG. 2 depicts a diagnostic functionality approach for carrying out diagnostic functionality via a parent device drive interface of a parent-child driver arrangement.

FIG. 3 depicts a diagnostic functionality approach for carrying out diagnostic functionality via a child device drive interface of a parent-child driver arrangement.

FIG. 4 depicts a computer system configured for carrying out system management and system diagnostic functionality in accordance with an embodiment of the inventive disclosures made herein.

### DETAILED DESCRIPTION OF THE DRAWINGS

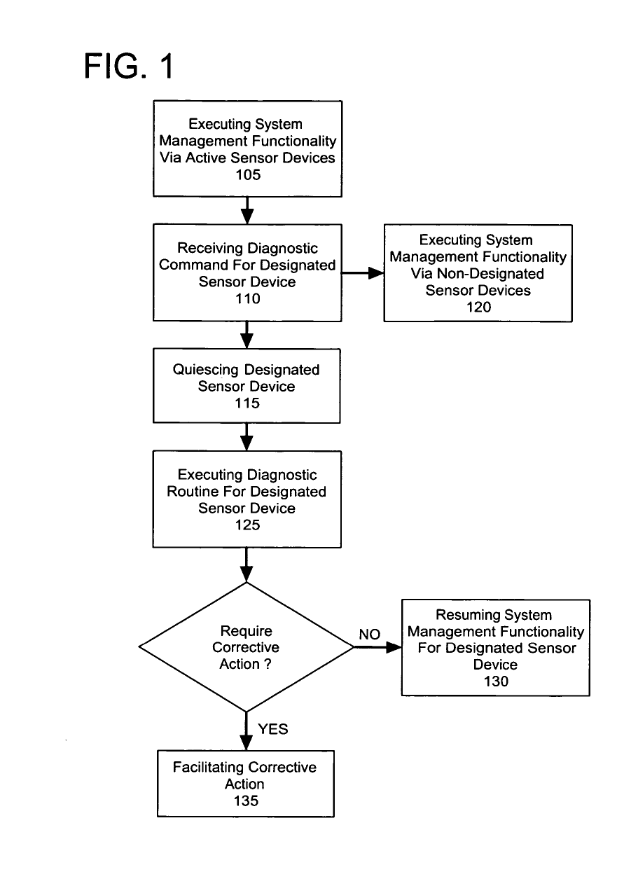

FIG. 1 depicts a method 100 configured for carrying out system management and diagnostic functionality in accordance with an embodiment of the inventive disclosures made herein. The method 200 is configured for enabling computer system 100 (e.g., a server) configured for enabling system diagnostic functionality to be performed on a system component sensor device of a computer system in a manner that does not require all system management functionality to be disabled while performing such system diagnostics. In this manner, the method 100 advantageously permits diagnostic functionality on system component sensor devices to be performed with minimal adverse affect on system down-time.

In the method 100, an operation 105 is performed for executing system management functionality (e.g., monitoring system component functionality) via active sensor devices. In response to an operation 110 being performed for receiving a diagnostic command for sensor devices designated in the diagnostic command (i.e., designated sensor device) while executing system management functionality, an operation 115 is performed for quiescing the designated sensor device and an operation 120 is performed for executing system management functionality via non-designated sensor devices.

After quiescing of the designated sensor device is performed, an operation 125 is performed for executing a diagnostic routine for the designated sensor device. Examples of such a diagnostic routine is a routine that evaluates output information of a sensor device in response to applying controlled and known input information. If corrective action is determined to not be required in response to executing the diagnostic routine (i.e., the designated sensor device is operating within acceptable parameters), an operation 130 is performed for resuming system management functionality for the designated sensor device (i.e., unquiescing the designated sensor device). If corrective action is determined to be required in response to executing the diagnostic routine (i.e., the designated sensor device is operating within acceptable parameters), an operation 135 is performed for facilitating such corrective action (e.g., issuing a diagnostic report).

It is contemplated herein that one embodiment of the method includes quiescing a designated group of sensor devices (i.e., including the designated sensor device), executing diagnostic routines on the designated group of sensor devices and resuming management functionality for the designated group of sensor devices.

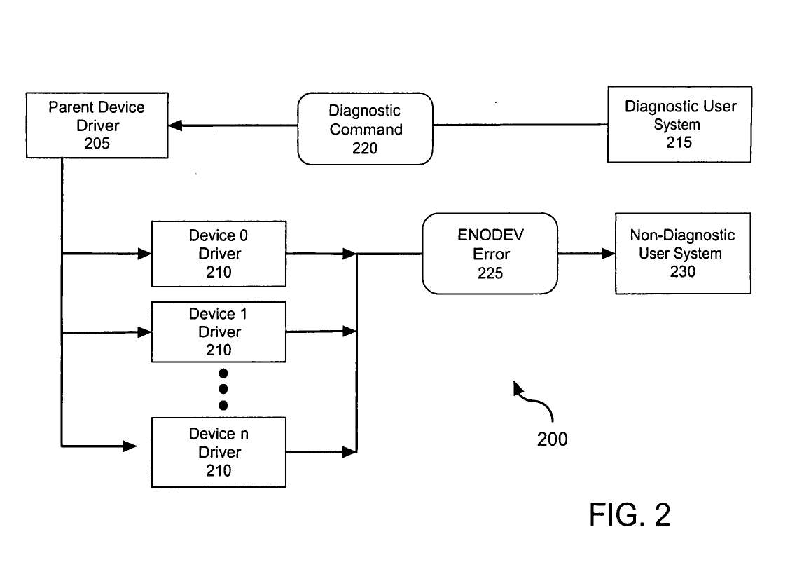

FIG. 2 depicts a diagnostic functionality approach 200 for carrying out diagnostic functionality in accordance with a first embodiment of the inventive disclosures made herein. The diagnostic arrangement 200 includes a parent device driver 205 and a plurality of child device drivers 210 (i.e., a parent-child driver arrangement). The parent-child driver arrangement provides for one parent device node and one or more child device nodes subtending from the parent device node.

The parent device driver 205 and the child device drivers 210 provide respective generic patent and child diagnostic interfaces to a diagnostic user system 215. The parent device driver provides an interface for controlling all the child devices simultaneously. Each child device driver provides an interface for monitor/control of at least one specific respective sensor device. Each one of the child device drivers drives a respective sensor device and, in some cases, a respective system component. The child device driver interfaces each enable monitoring and/or control of sensor data from a respective sensor device of a computing system (e.g., server). Examples of such sensor devices include fan speed sensors, die temperature sensors, die voltage sensors and the like.

The parent device diagnostic interface enables the diagnostic user system 215 to put all of the child device drivers 210 subtending from the parent device driver 205 into a diagnostics mode of operation in response to a diagnostic command 220 being issued from the diagnostic user system 215 and received by the parent device driver 205. After receiving the diagnostic command 220, only diagnostic user systems (e.g., the diagnostic user system 215 as used for access by an authorized diagnostics user) are allowed to quiesce or unquiesce the device drivers. While the child device drivers are in the diagnostic mode of operation, the device drivers return corresponding messages (e.g., ENODEV—Error No Device message 225) indicating the current state of the respective sensor devices when accessed by a non-diagnostic user system 230. Similarly, a system user that is listening via the non-diagnostic user system 230 for events from the sensor devices of a quiesced device driver is notified that the respective device driver is entering into or getting out of the diagnostics mode of operation.

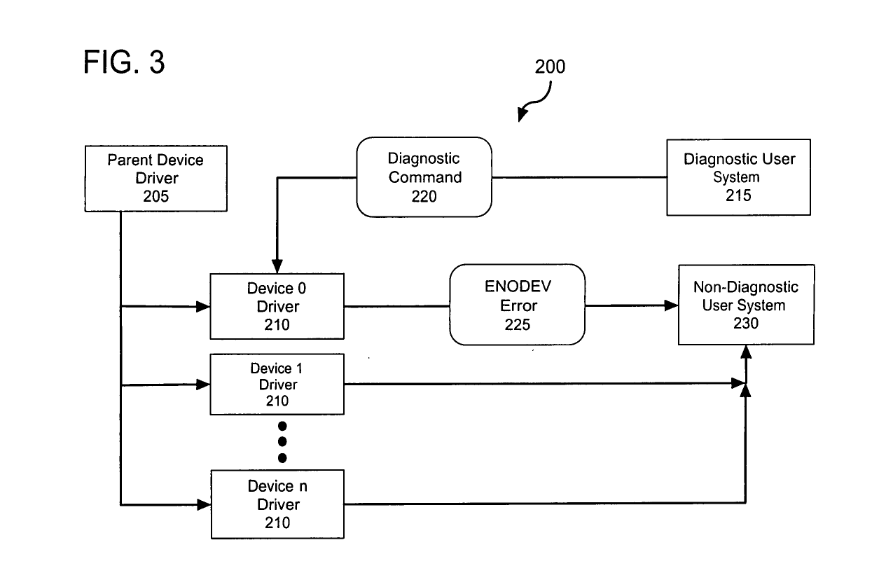

FIG. 3 depicts the diagnostic functionality approach 200 for carrying out diagnostic functionality in accordance with a second embodiment of the inventive disclosures made herein. The child device diagnostic interface allows the diagnostic user system to put a designated one of the child device drivers 210 (i.e., the designated child device driver) of a specific respective sensor device into a diagnostics mode of operation in response to the diagnostic command 220 being issued from the diagnostic user system 215 and received by the designated one of the child device drivers 210. After receiving the diagnostic command 220, only diagnostic user systems (e.g., the diagnostic user system 215 as used for access by an authorized diagnostics user) are allowed to quiesce or unquiesce the designated child device. While the designated child device driver is in the diagnostic mode of operation, the designated child device driver returns a corresponding message (e.g., ENODEV—Error No Device message 225) indicating the current state of the respective sensor device when accessed by a non-diagnostic user system 230. However, system management functionality via non-designated device drivers continues to be enabled for non-diagnostic users.

As depicted in FIGS. 2 and 3, because every device driver supports a diagnostics interface independently, it is possible to individually quiesce a device for diagnostics purposes. Also, the user may choose to quiesce a similar group of sensor devices simultaneously using their parent device interface. This allows for diagnostics to be selectively run while still running the rest of the computing system in a normal mode of operation. This ability to selective impart the diagnostic mode of operation contributes to reduce the comprehensive downtime of the server sensor components. Also, this mechanism allows for targeting of specific system component failures without compromising operation of most system functionality. For example, if a fan failure occurred, a system administrator has the ability to set only the device driver used to control this fan to the diagnostic mode of operation (i.e., quiesce only this device driver). The rest of the fans can still be monitored and controller by system management components.

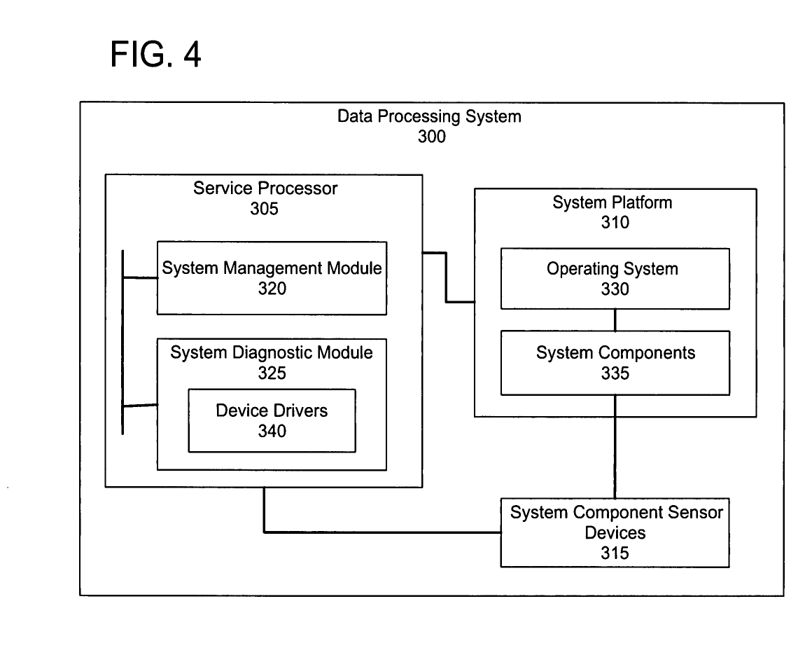

FIG. 4 depicts a system 300 (e.g., a server) configured for facilitating system diagnostics in accordance with an embodiment of the inventive disclosures made herein. The system 300 includes a service processor 305, a system platform 310 and system component sensor devices 315. The service processor 305 facilitates functionality such as remote management, diagnostics, discovery and/or monitoring support of the platform-side operating system. The service processor 305 is connected to the system platform 310 for enabling interaction therebetween. The system component sensor devices 315 are coupled between the service processor 305 and the system platform 310 for enabling interaction therebetween. The service processor 305 includes a system management module 320 and a system diagnostic module 325. The system platform 310 includes an operating system 330 and system components 335 connected to the operating system 330 for enabling interaction therebetween.

The system management module 320 is configured for facilitating system management functionality within the system platform 310. For example, the system management module 320 includes software hardware and/or firmware for enabling facilitation of such system management functionality. Device drivers 340 are coupled between the service processor 305 and the system component sensor devices 315 for enabling interaction therebetween. For example, the system management module 320 and the system diagnostic module 325 interact with the device drivers 340 for facilitating respective functionality. Issuing diagnostic commands, selectively setting device drivers the diagnostic mode of operation (i.e., selective quiescing) and facilitating diagnostic routines are examples of functionality facilitated by the system diagnostic module 325.

It is contemplated herein that the system diagnostic module 325 includes software, hardware and/or firmware for enabling facilitation of such system management functionality. In one embodiment, the device drivers 340 are configured for enabling selective quiescing without requiring modification to conventional system diagnostic software comprised by the system diagnostic module 325. In such an embodiment, the device drivers return a standard error value that system management software comprised by the system management module 320 is already configured for receiving and interpreting. This error value causes calling software to wait and retry, thus quiesced hardware simply appears to be temporarily unavailable. Typically, there is a timeout, such that callers will not have to wait forever for a long diagnostic.

The following definitions are not intended to be limiting, but are provided to aid the reader in properly interpreting the detailed description of the present invention. It will be appreciated that a judge or jury may eventually interpret the terms defined herein, and that the exact meaning of the defined terms will evolve over time. The word “module” as used herein refers to any piece of code that provides some diagnostic functionality. Some examples of modules as used herein include device drivers, command interfaces, executives, and other applications. The phrase “device drivers,” as used herein and sometimes referred to as service modules, refers to images that provide service to other modules in memory. A driver can “expose a public interface,” that is, make available languages and/or codes that applications use to communicate with each other and with hardware. Examples of exposed interfaces include an ASPI (application specific program interface), a private interface, e.g., a vendor's flash utility, or a test module protocol for the diagnostic platform to utilize. The word “platform” as used herein generally refers to functionality provided by the underlying hardware. Such functionality may be provided using single integrated circuits, for example, various information processing units such as central processing units used in various information handling systems. Alternatively, a platform may refer to a collection of integrated circuits on a printed circuit board, a stand-alone information handling system, or other similar devices providing the necessary functionality. The term platform also describes the type of hardware standard around which a computer system is developed. In its broadest sense, the term platform encompasses service processors that provide diagnostic functionality, as well as processors that provide server functionality. The word “server” as used herein refers to the entire product embodied by the present disclosure, typically a service processor (SP) and one or more processors. In an embodiment, the one or more processors are AMD K8 processors, or other processors with performance characteristics meeting or exceeding that of AMD K8 processors.

Referring now to computer readable medium in accordance with embodiments of the disclosures made herein, methods, processes and/or operations as disclosed herein for enabling disclosed system diagnostic functionality are tangibly embodied by computer readable medium having instructions thereon for carrying out such methods, processes and/or operations. In one specific example, instructions are provided for carrying out the various operations of the methods, processed and/or operations depicted in FIGS. 1-3 and/or associated with the system depicted in FIG. 4. The instructions may be accessible by one or more processors (i.e., data processing devices providing service processor functionality) of a system as disclosed herein (i.e., a server) from a memory apparatus of the computer system (e.g. RAM, ROM, flash memory, virtual memory, hard drive memory, etc). Examples of computer readable medium include a compact disk or a hard drive, which has imaged thereon a computer program adapted for carrying out disclosed system diagnostic functionality.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical, mechanical, chemical and electrical changes may be made without departing from the spirit or scope of the invention. For example, functional blocks shown in the figures could be further combined or divided in any manner without departing from the spirit or scope of the invention. To avoid unnecessary detail, the description omits certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

1. A driver for a system component sensor device in a computer system, comprising:
a diagnostic mode of operation configured for enabling selective execution of diagnostic functionality on a corresponding system component sensor device while concurrently permitting execution of system management to be performed via system component sensors in a system management mode of operation.

2. The driver of claim 1 wherein the diagnostic mode of operation includes disabling the corresponding system component device with respect to system management functionality and access by non-diagnostic users.

3. The driver of claim 1 wherein said diagnostic functionality includes at least one of:
issuing a message indicating that the corresponding system component sensor device is inaccessible when accessed by a non-diagnostic user while the corresponding system component sensor device is in the diagnostic mode of operation;
issuing a message to the non-diagnostic user indicating that the corresponding system component sensor device is transitioning to the diagnostic mode of operation from the system management mode of operation; and
issuing a message to the non-diagnostic user indicating that the corresponding system component sensor device is transitioning to the system management mode of operation from the diagnostic mode of operation.

4. The driver of claim 1, further comprising:
at least one of a parent device driver interface and a child device drive interface.

5. The driver of claim 1, further comprising:
a parent driver device interface configured for controlling modes of operation of a group of child sensor devices; and
a plurality of child device driver interfaces each configured for controlling modes of operation of a respective one of said child sensor devices, wherein the corresponding system component sensor device is one of said sensor devices and is set to the diagnostic mode of operation using one of said device driver interfaces.

6. A method for facilitating diagnostic functionality in a computer system, comprising:
setting a designated sensor device of a system component to a diagnostic mode of operation;
executing system management functionality on system components served by non-designated sensor devices while the designated sensor device is in the diagnostic mode of operation; and
executing diagnostic functionality on the designated sensor device while executing said system management functionality and while the designated sensor device is in the diagnostic mode of operation.

7. The method of claim 6 wherein:
said setting to the diagnostic mode of operation includes setting a device driver corresponding to the designated sensor device to the diagnostic mode of operation.

8. The method of claim 6 wherein:
said setting to the diagnostic mode of operation includes simultaneously setting a plurality of sensor devices to the diagnostic mode of operation; and
the designated sensor device is one of said sensor devices.

9. The method of claim 6 wherein executing said diagnostic functionality includes at least one of:
issuing a message indicating that the corresponding system component sensor device is inaccessible when accessed by a non-diagnostic user while the corresponding system component sensor device is in the diagnostic mode of operation;
issuing a message to the non-diagnostic user indicating that the corresponding system component sensor device is transitioning to the diagnostic mode of operation from the system management mode of operation; and
issuing a message to the non-diagnostic user indicating that the corresponding system component sensor device is transitioning to the system management mode of operation from the diagnostic mode of operation.

10. The method of claim 6 wherein:
said setting to the diagnostic mode of operation includes disabling the designated sensor device from at least one of providing system management functionality and being accessed by non-diagnostic users.

11. A computer system, comprising:
at least one data processing device;
instructions processable by said at least one data processing device; and
an apparatus from which said instructions are accessible by said at least one data processing device;
wherein said instructions are configured for enabling said at least one data processing device to facilitate:
setting a designated sensor device of a system component to a diagnostic mode of operation;
executing system management functionality on system components served by non-designated sensor devices while the designated sensor device is in the diagnostic mode of operation; and
executing diagnostic functionality on the designated sensor device while executing said system management functionality and while the designated sensor device is in the diagnostic mode of operation.

12. The computer system of claim 11 wherein:
said setting to the diagnostic mode of operation includes setting a device driver corresponding to the designated sensor device to the diagnostic mode of operation.

13. The computer system of claim 11 wherein:
said setting to the diagnostic mode of operation includes simultaneously setting a plurality of sensor devices to the diagnostic mode of operation; and
the designated sensor device is one of said sensor devices.

14. The computer system of claim 11 wherein executing said diagnostic functionality includes at least one of:
issuing a message indicating that the corresponding system component sensor device is inaccessible when accessed by a non-diagnostic user while the corresponding system component sensor device is in the diagnostic mode of operation;
issuing a message to the non-diagnostic user indicating that the corresponding system component sensor device is transitioning to the diagnostic mode of operation from the system management mode of operation; and
issuing a message to the non-diagnostic user indicating that the corresponding system component sensor device is transitioning to the system management mode of operation from the diagnostic mode of operation.

15. The computer system of claim 11 wherein:
said setting to the diagnostic mode of operation includes disabling the designated sensor device from at least one of providing system management functionality and being accessed by non-diagnostic users.

16. The computer system of claim 11 wherein:
said data processing instructions comprises a device driver including at least one of a parent device driver interface and a child device drive interface; and
said setting the designated sensor device of a system component to a diagnostic mode of operation is facilitated using at least one of the parent driver device interface and the child drive interface.

17. The computer system of claim 11 wherein:
said data processing program comprises a parent driver device interface configured for controlling modes of operation of a group of child sensor devices and child device driver interface configured for controlling a respective mode of operation of a respective one of said child sensor devices; and
said setting the designated sensor device of a system component to a diagnostic mode of operation is facilitated using at least one of the parent driver device interface and the child drive interface.
